(19) United States
(12) Patent Application Publication
(10) Pub. No.: US 2019/0229415 A1
(43) Pub. Date: Jul. 25, 2019

(54) Radio-Frequency Apparatus with Integrated Antenna Control and Associated Methods

(71) Applicants: David Le Goff, Rennes (FR); John M. Khoury, Austin, TX (US); Mustafa Koroglu, Austin, TX (US); Abdulkerim Coban, Austin, TX (US); Ramin Khoini-Poorfard, Austin, TX (US)

(72) Inventors: David Le Goff, Rennes (FR); John M. Khoury, Austin, TX (US); Mustafa Koroglu, Austin, TX (US); Abdulkerim Coban, Austin, TX (US); Ramin Khoini-Poorfard, Austin, TX (US)

(21) Appl. No.: 16/370,987

(22) Filed: Mar. 30, 2019

Related U.S. Application Data
(62) Division of application No. 15/390,434, filed on Dec. 23, 2016.
Application No. 15/390,434 is a continuation-in-part of application No. 14/869,916, filed on Sep. 29, 2015.

(51) Int. Cl. H01Q 1/50; H01Q 1/22; H01Q 21/28; H04B 7/08; H01Q 3/24

(52) U.S. Cl. CPC H01Q 1/50; H01Q 1/2283; H01Q 21/28; H04L 67/12; H01Q 3/24; H01Q 1/2291; H04B 7/0805

(57) ABSTRACT

An apparatus includes a first integrated circuit (IC) that includes a first radio-frequency (RF) circuit to process RF signals, a first antenna port to couple to one or more antennas, and a first switch integrated in the first IC and coupled to the first antenna port. The apparatus further includes a second IC that includes a second RF circuit to process RF signals, a second antenna port to couple to the one or more antennas, and a second switch integrated in the second IC and coupled to the second antenna port.

### CROSS-REFERENCE TO RELATED APPLICATIONS

This application is a continuation-in-part (CIP) of, and incorporates by reference in its entirety for all purposes, U.S. patent application Ser. No. 14/869,916, filed on Sep. 29, 2015, titled “Radio-Frequency Apparatus with Integrated Antenna Control and Associated Methods,” attorney docket number SILA365.

### TECHNICAL FIELD

The disclosure relates generally to radio-frequency (RF) apparatus and methods. More particularly, the disclosure relates to RF apparatus with integrated antenna control, and associated methods.

### BACKGROUND

With the increasing proliferation of wireless technology, such as Wi-Fi, Bluetooth, and mobile or wireless Internet of things (IoT) devices, more devices or systems incorporate RF circuitry, such as receivers and/or transmitters. To reduce the cost, size, and bill of materials, and to increase the reliability of such devices or systems, various circuits or functions have been integrated into integrated circuits (ICs). For example, ICs typically include receiver and/or transmitter circuitry.

In a radio receiver (or transmitter), having two receive (or transmit) antennae can improve reception (or transmission). In one form, a “diversity” receiver can selects one antenna from a group of antennae, for example, two antennae, based on some pre-determined criterion. In typical implementations of antenna diversity, an off-chip (not integrated) antenna switch and/or front-end module (FEM) is controlled by the radio IC.

The description in this section and any corresponding figure(s) are included as background information materials. The materials in this section should not be considered as an admission that such materials constitute prior art to the present patent application.

### SUMMARY

A variety of apparatus and associated methods are contemplated according to exemplary embodiments. According to one exemplary embodiment, an apparatus includes a first IC that includes a first RF circuit to process RF signals, a first antenna port to couple to one or more antennas, and a first switch integrated in the first IC and coupled to the first antenna port. The apparatus further includes a second IC that includes a second RF circuit to process RF signals, a second antenna port to couple to the one or more antennas, and a second switch integrated in the second IC and coupled to the second antenna port.

According to another exemplary embodiment, an apparatus includes a first IC, which includes a first RF circuit to process RF signals. The first IC further includes a first switch, integrated in the first IC and coupled to an antenna port of the first IC, in order to share at least one antenna coupled to the antenna port of the first IC.

According to another exemplary embodiment, a method of sharing at least one antenna between a first IC having a first switch integrated in the first IC and coupled to a first antenna port, and a second IC having a second switch integrated in the second IC and coupled to a second antenna port, includes closing the first switch to couple the at least one antenna to the second IC. The method further includes opening the second switch to in order for RF circuitry in the second IC to use the at least first antenna.

### BRIEF DESCRIPTION OF THE DRAWINGS

The appended drawings illustrate only exemplary embodiments and therefore should not be considered as limiting the scope of the application or the claims. Persons of ordinary skill in the art appreciate that the disclosed concepts lend themselves to other equally effective embodiments. In the drawings, the same numeral designators used in more than one drawing denote the same, similar, or equivalent functionality, components, or blocks.

FIG. 1 illustrates a circuit arrangement for an apparatus according to a first exemplary embodiment.

FIG. 2 depicts a circuit arrangement for an apparatus according to a second exemplary embodiment.

FIG. 3 shows a circuit arrangement for an apparatus according to a third exemplary embodiment.

FIG. 4 depicts a circuit arrangement for an apparatus according to a fourth exemplary embodiment.

FIG. 5 illustrates a circuit arrangement for an apparatus according to a fifth exemplary embodiment.

FIG. 6 depicts a circuit arrangement for an apparatus according to a sixth exemplary embodiment.

FIG. 7 illustrates a first switch for use in apparatus according to exemplary embodiments.

FIG. 8 shows a second switch for use in apparatus according to exemplary embodiments.

FIG. 9 depicts a circuit arrangement for a switch for use in apparatus according to exemplary embodiments.

FIG. 10 illustrates another circuit arrangement for a switch for use in apparatus according to exemplary embodiments.

FIG. 11 shows a conventional scheme for sharing an antenna.

FIG. 12 depicts a circuit arrangement for sharing two antennas according to an exemplary embodiment.

FIG. 13 illustrates a circuit arrangement for sharing two antennas according to another exemplary embodiment.

FIG. 14 shows a circuit arrangement for sharing an antenna according to an exemplary embodiment.

FIG. 15 depicts a circuit arrangement for sharing an antenna according to another exemplary embodiment.

FIG. 16 illustrates a circuit arrangement for sharing two antennas according to another exemplary embodiment.

FIG. 17 shows a circuit arrangement for sharing two antennas according to another exemplary embodiment.

FIG. 18 depicts a circuit arrangement for sharing an antenna according to another exemplary embodiment.

FIG. 19 illustrates a circuit arrangement for sharing an antenna according to another exemplary embodiment.

FIG. 20 shows a circuit arrangement for coordination of antenna sharing according to an exemplary embodiment.

FIG. 21 depicts a circuit arrangement for coordination of antenna sharing according to another exemplary embodiment.

### DETAILED DESCRIPTION

The disclosed concepts relate generally to RF apparatus. More specifically, the disclosed concepts relate to RF apparatus with integrated antenna control, and associated methods. In exemplary embodiments, an IC includes within it integrated control circuitry, antenna interface circuitry, and/or switches that interface with two or more antennae in an antenna diversity scheme.

In a radio receiver (and/or transmitter), having two receive (and/or transmit) antennae can improve reception (and/or transmission). In typical implementations of antenna diversity, an off-chip antenna switch and/or front-end module (FEM) is controlled by a controller. The controller may reside in the same IC as does the RF circuitry. For example, one (or more) general-purpose input/output (GPIO) on the IC may be used to control the antenna diversity switch(es) from the radio IC.

Antenna diversity implementations according to exemplary embodiments eliminate the external FEM or switches. More specifically, in exemplary embodiments, the antenna selection switching and related control are integrated within the same IC that includes the RF circuitry (receive and/or transmit circuitry).

Various embodiments according to the disclosure provide a number of advantages over conventional approaches. For example, integrating the control circuitry, antenna interface circuitry, and/or switches within the IC eliminates the use of off-chip circuitry or components. Furthermore, elimination of the off-chip circuitry or components results in saving one or more package pins of the IC (that would ordinarily be used to control off-chip circuitry/components). In addition, reducing the number and size of the components as a result of the increased integration reduces the overall size, cost, and bill-of-materials for the circuit, block, sub-system, or system in which the RF circuit or device resides.

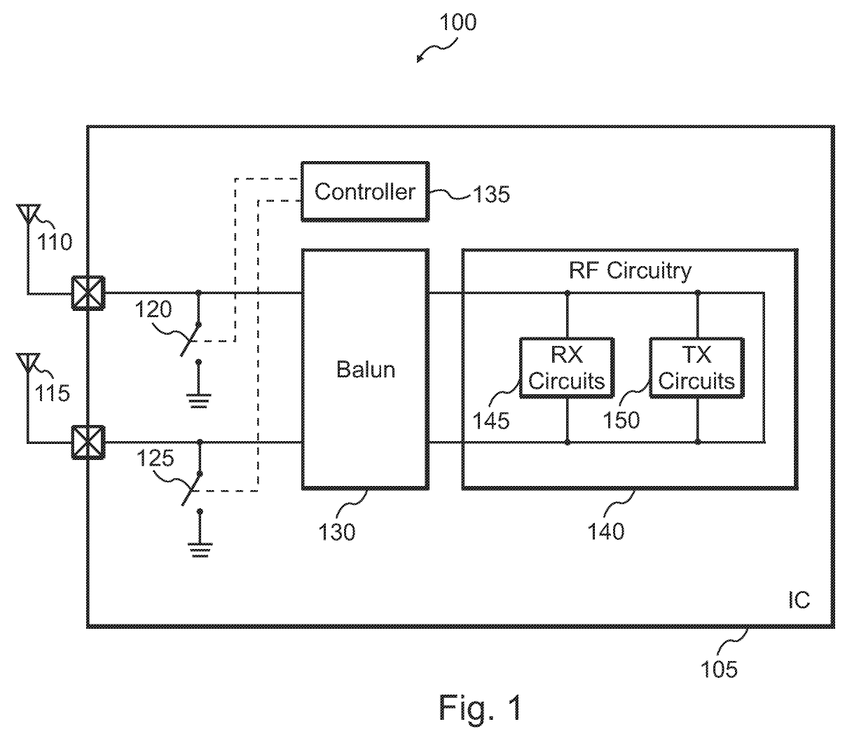

FIG. 1 illustrates a circuit arrangement 100 for antenna control according to an exemplary embodiment. Circuit arrangement 100 includes IC 105, antenna 110, and antenna 115. IC 105 includes switch 120, switch 125, balun 130, controller 135, and RF circuitry 140. RF circuitry 140 includes receive circuits (labeled “RX circuits”) 145 and/or transmit circuits (labeled “TX circuits”) 150.

Note that FIG. 1 shows a block diagram of circuit arrangement 100, and that other blocks of circuitry may be included, as desired. For example, in some embodiments, apparatus 100 may include power supply or conversion circuits, control circuits, and the like, as persons of ordinary skill in the art will understand.

As noted, in some embodiments, receive circuits 145 are used in order to receive and process RF signals via one of antennae 110 and 115. When used in exemplary embodiments, receive circuits 145 may include a variety of circuits, such as downconverters, analog-to-digital converters (ADCs), digital-to-analog converters (DACs), decoders, demodulators, error-correction circuitry, amplifiers (including low-noise amplifiers (LNAs), signal sources (such as frequency synthesizers), and the like, as persons of ordinary skill in the art will understand. The choice of circuits included or used in receive circuits 145 depends on factors such as design and performance specifications, intended use, cost and performance goals, etc., as persons of ordinary skill in the art will understand.

As noted, in some embodiments, transmit circuits 150 is used in order to process and transmit RF signals via one of antennae 110 and 115. When used in exemplary embodiments, transmit circuits 150 may include a variety of circuits, such as upconverters, analog-to-digital converters (ADCs), digital-to-analog converters (DACs), encoders, modulators, amplifiers (including power amplifiers (PAs), signal sources (such as frequency synthesizers), and the like, as persons of ordinary skill in the art will understand. The choice of circuits included or used in transmit circuits 150 depends on factors such as design and performance specifications, intended use, cost and performance goals, etc., as persons of ordinary skill in the art will understand.

Receive circuits 145 and/or transmit circuits 150 are coupled to antenna 110 and antenna 115 via balun 130. Specifically, receive circuits 145 and/or transmit circuits 150 are coupled to one port of balun 130. A second port of balun 130 couples to antenna 110 and antenna 115. The second port of balun 130 also couples to switch 120 and to switch 125.

More specifically, one node of the second port of balun 130 couples to antenna 110 and to switch 120. Switch 120, when closed, blocks antenna 110 or, stated another way, shorts to ground the signal to/from antenna 110. When open, however, switch 120 allows the signal to/from antenna 110 to couple to receive circuits 145 and/or transmit circuits 150. Thus, if receive circuits 145 are used, the signal from antenna 110 is provided to receive circuits 145 via balun 130. If transmit circuits 150 are used, the signal from transmit circuits 150 is provided to antenna 110 via balun 130.

Similarly, another node of the second port of balun 130 couples to antenna 115 and to switch 125. When closed, switch 125 blocks antenna 115. Put another way, when closed, switch 125 shorts to ground the signal to/from antenna 115. On the other hand, when open, switch 125 allows the signal to/from antenna 115 to couple to receive circuits 145 and/or transmit circuits 150. If receive circuits 145 are used, the signal from antenna 115 is provided to receive circuits 145 via balun 130. If transmit circuits 150 are used, the signal from transmit circuits 150 is provided to antenna 115 via balun 130.

A controller 135 controls the operation of switch 120 and switch 125. More specifically, controller 135 opens and closes switch 120 and switch 125 in order to select antenna 110 or antenna 115 to receive or transmit RF signals (i.e., by using receive circuits 145 or transmit circuits 150, respectively, in RF circuitry 140).

For example, suppose that one seeks to receive RF signals via antenna 110. Controller 135 causes switch 120 to open, and switch 125 to close. As noted, when closed, switch 125 blocks antenna 115, i.e., shorts to ground the signal from antenna 115. As a result, the RF signal from antenna 110 is provided to RF circuitry 140 (more specifically to receive circuits 145) via balun 130.

As another example, a similar scenario may be used to transmit RF signals from antenna 110. In this situation, controller 135 causes switch 120 to open, and switch 125 to close. When closed, switch 125 blocks antenna 115, i.e., shorts to ground the signal that would otherwise reach antenna 115. As a result, the RF signal from RF circuitry 140 (more specifically from transmit circuits 150) is provided to antenna 110 via balun 130.

Conversely, controller 135 may control switch 110 and switch 115 in a similar manner in order to use antenna 115, rather than antenna 110. For instance, suppose that one seeks to receive RF signals via antenna 115. To accomplish that goal, controller 135 causes switch 125 to open, and switch 120 to close. As noted, when closed, switch 120 blocks antenna 110, i.e., shorts to ground the signal from antenna 110. Consequently, the RF signal from antenna 115 is provided to RF circuitry 140 (more specifically to receive circuits 145) via balun 130.

As another example, suppose that one seeks to transmit RF signals from antenna 115. To do so, controller 135 causes switch 125 to open, and switch 120 to close. By virtue of switch 120 being closed, it blocks antenna 110, i.e., shorts to ground the signal that would otherwise reach antenna 110. As a result, the RF signal from RF circuitry 140 (more specifically from transmit circuits 150) is provided to antenna 115 via balun 130.

Thus, using switch 120 and switch 125 allows shorting to ground an antenna path corresponding to an unselected antenna, as described above. Doing so allows the antenna path corresponding to the selected antenna to be enabled and for the selected antenna to be available for reception or transmission, as desired. Furthermore, note that the active or selected antenna path does not pass through any switches, which provides higher linearity and lower noise compared to the case where switches (e.g., external to IC 105) are used to connect or disconnect the antennae from IC 105.

Generally speaking, a variety of balun configurations may be used, as desired. The choice of the type and configuration of the balun depends on a variety of factors, as persons of ordinary skill in the art will understand. Such factors include performance and design considerations for IC 105, cost, IC die area, available fabrication technology, ease of design, manufacturing, and/or testing, etc.

Note that the first port of balun 130 couples to RF circuitry 150 in a balanced configuration. Conversely, the second port of balun 130 couples to antenna 110 or antenna 115 in an unbalanced configuration. More specifically, to select one of antenna 110 and antenna 115 to receive RF signals or to transmit RF signals, one of switches 120 and 125 is opened, and the other of switches 120 and 125 is closed. As a result, the second port of balun 130 is coupled to the selected antenna in an unbalanced configuration.

In some embodiments, balun 130 includes a transformer. In such a scenario, receive circuits 145 and/or transmit circuits 150 are coupled to one winding or side of the transformer, say, the primary or primary winding. Similarly, antenna 110, antenna 115, switch 120, and switch 125 are coupled to the other winding or side of the transformer, in this example, the secondary or secondary winding. In effect, in the example described, the balun constitutes a two-port network, with the primary and secondary sides or windings of the transformer corresponding to the first and second ports of the two-port network, respectively.

Note that, in some embodiments, rather than using a transformer-based balun 130 as shown in FIG. 1, multiple matching networks, such as inductor-capacitor (LC) networks, may be integrated in IC 105 and used. The matching networks would in such embodiments couple RF circuitry 140 to antenna 110 and antenna 115. By activating receive circuits 145 or transmit circuits 150, RF circuitry may receive or transmit RF signals via the matching networks, respectively.

As noted above, by using controller 135, antenna 110 or antenna 115 may be used for RF signal reception or transmission as part of an antenna diversity scheme. In exemplary embodiments, the selection of antenna 110 or antenna 115 by controller 135 may be performed in variety of ways.

For instance, in some embodiments, during power-up or configuration of IC 105, controller 135 may be instructed or programmed or configured to use antenna 110 or antenna 115. As another example, alternatively or in addition, controller 135 may be instructed or programmed or configured to use antenna 110 or antenna 115 during use of IC 105, for example, in response to instructions by a user of IC 105 or another block or circuit or subsystem in a system or apparatus that uses or includes IC 105.

As another example, controller 135 may select antenna 110 or antenna 115 dynamically during operation of IC 105, based on one or more criteria. The selected antenna may be used to receive RF signals, to transmit RF signals, or both, as desired.

An example of antenna selection criteria may include signal strength. More specifically, receiver circuits 145 may receive an RF signal using antenna 110 and also using antenna 115. The strength (level, power, received signal strength indication (RSSI), etc.) of the received RF signal when using antenna 110 may be compared to the strength of the received RF signal when using antenna 115. The antenna corresponding to the stronger received RF signal may then be selected and used for further RF signal reception.

In some embodiments, the selected antenna may also be used for RF signal transmission, as desired. In other embodiments, one or more different or additional criteria may be used to select an antenna for RF signal transmission, as desired.

For example, an antenna may be selected, and an RF signal transmitted using that antenna. An assessment of the strength of a received signal corresponding to the transmitted signal may be made (e.g., by a remote receiver). This operation may be repeated by selecting and using the other antenna. Depending on which of the received signals corresponding to antenna 110 and antenna 115 is stronger, antenna 110 or antenna 115 may be used for additional RF signal transmission.

Note that FIG. 1 shows a generalized block diagram of an apparatus that includes both RF signal reception and RF signal transmission capability. A variety of alternatives are possible and contemplated. For example, in some embodiments, RF signal reception capability, but not RF signal transmission capability, may be desired. In such embodiments, transmit circuits 150 may be omitted, and receive circuits 145 may be used for RF signal reception.

As another example, in some embodiments, RF signal transmission capability, but not RF signal reception capability, may be desired. In such embodiments, receive circuits 145 may be omitted, and transmit circuits 150 may be used for RF signal transmission.

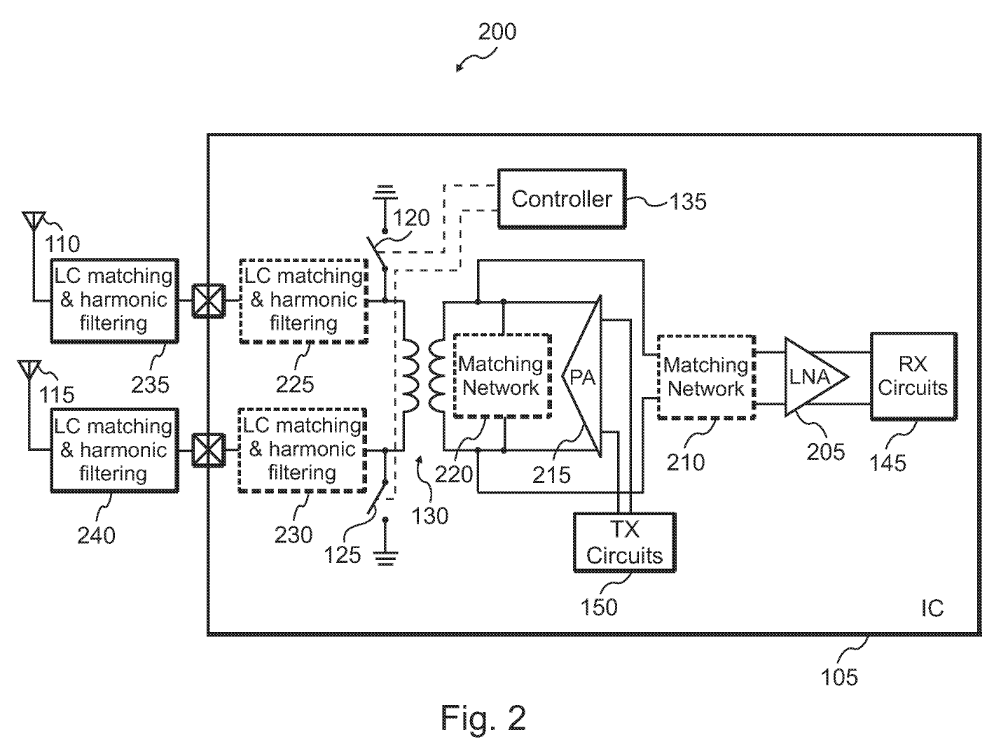

Whether IC 105 includes RF reception capability, RF transmission capability, or both, the antenna control circuitry that includes switch 120 and switch 125 may be used advantageously, as described. Similar considerations and comments apply to the circuit arrangements in FIGS. 2-6.

Another aspect of the disclosure relates to using matching networks, sometimes called impedance matching networks, with antenna control circuitry. The matching networks provide a mechanism for coupling together circuitry or blocks of circuitry that might otherwise have impedance mismatches.

For example, an antenna might present a given characteristic impedance, say, Zₐₙₜ, whereas RF circuitry 140 (whether receive circuits 145 or transmit circuits 150, or both) might have a characteristic impedance Z_{RF}, with a complex conjugate Z_{RF}*. As persons of ordinary skill in the art understand, to achieve maximum power transfer to/from such an antenna to/from RF circuitry (at radio frequencies, designers often seek to reduce power loss and maximize power transfer), the following relationship should hold:

Zₐₙₜ=Z_{RF}*.

If, by virtue of their design or characteristics, the antenna and RF circuitry 140 have difference characteristic impedances, i.e., Zₐₙₜ≠Z_{RF}*, one or more matching networks may be used in order to match Zₐₙₜ to Z_{RF}*. The matching networks typically are coupled between the devices or circuits (or to the devices or circuits) that have differing impedances, such as the antenna and RF circuitry 140, in the above example.

FIG. 2 illustrates a circuit arrangement 200 for antenna control according to an exemplary embodiment. Circuit arrangement 200 operates in a similar manner to circuit arrangement 100 (see FIG. 1), except for the addition of several matching networks (and explicitly illustrating PA 215 and LNA 205).

More specifically, referring to FIG. 2, circuit arrangement 200 includes LC matching and harmonic filtering networks 225 and 235. LC matching and harmonic filtering networks 225 and 235 are coupled between antenna 110 and balun 130. LC matching and harmonic filtering networks 225 and 235 provide impedance matching between antenna 110 and balun 130. In addition, LC matching and harmonic filtering networks 225 and 235 may provide filtering of harmonic signals (or other spurious or undesired signals) in the signal path between antenna 110 and balun 130.

Similarly, LC matching and harmonic filtering networks 230 and 240 are coupled between antenna 115 and balun 130. LC matching and harmonic filtering networks 230 and 240 provide impedance matching between antenna 115 and balun 130. In addition, LC matching and harmonic filtering networks 230 and 240 may provide filtering of harmonic signals (or other spurious or undesired signals) in the signal path between antenna 115 and balun 130.

Circuit arrangement 200 further includes matching network 220. Matching network 220 couples to PA 215 and balun 130, and provides impedance matching between them. Transmit circuits 150 drive PA 215 during the transmit mode of the apparatus in FIG. 2.

In addition, circuit arrangement 200 includes matching network 210. Matching network 210 is coupled between balun 130 and LNA 205, and provides impedance matching between them. LNA 205 amplifies the RF signal received from balun 130, and provides the amplified RF signal to receive circuits 145 during the receive mode of the apparatus in FIG. 2.

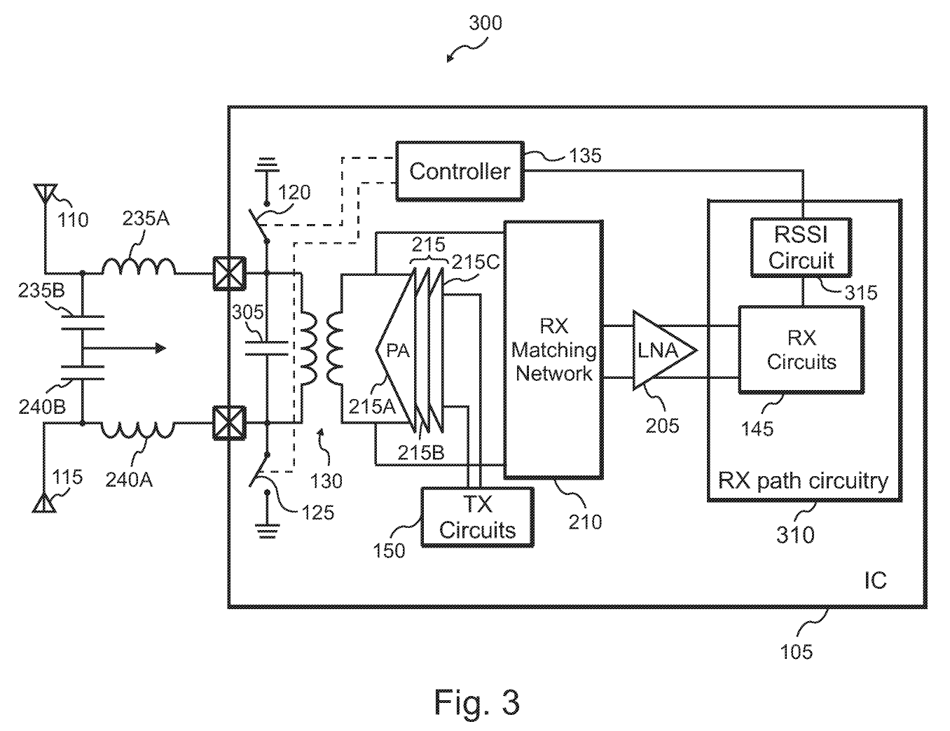

FIG. 3 illustrates a circuit arrangement 300 for antenna control according to an exemplary embodiment. Circuit arrangement 300 is similar to circuit arrangement 200 in FIG. 2, and operates in a similar manner Referring to FIG. 3, circuit arrangement 300 shows examples of some of the matching networks used to provide impedance matching between various circuit elements or blocks in the apparatus that includes IC 105.

More specifically, in the embodiment shown in FIG. 3, LC matching and harmonic filter 235 includes inductor 235A and capacitor 235B. Similarly, LC matching and harmonic filter 240 includes inductor 240A and capacitor 240B.

Capacitor 305 is used as another part of the matching network. Capacitor 305 is coupled across the second port of balun 130. Together with LC matching and harmonic filter 235 and LC matching and harmonic filter 240, capacitor 305 provides impedance matching between antennae 110 and 115 and balun 130.

Note that PA 215 in FIG. 3 includes several PA slices or PA circuits 215A-215C. PA slices 215A-215C may include circuitry for individual PAs. Depending on factors such as desired transmit power (or range), frequency or band of operation, and the like, one or more of PA slices 215A-215C may be activated and used to drive a selected one of antennae 110-115.

Circuit arrangement 300 shows three PA slices 215A, 215B, and 215C. As persons of ordinary skill in the art will understand, however, other numbers of PA slices may be used, depending on factors such as desired power levels, design and performance specifications, available technology, etc.

Circuit arrangement 300 shows receive path circuitry (labeled as “RX path circuitry”) 310, which includes receive circuits 145 and RSSI circuit 315. RSSI circuit 315 determines a signal strength of the RF signal received by receive circuits 145 via a selected one of antennae 110-115. RSSI circuit 315 provides an indication of the received signal strength to controller 135. Controller 135 may use the information or indication of the received signal strength as a criterion in selecting one of antennae 110-115 by using switches 120-125, as described above in detail.

As noted above, RF circuitry 140 in FIG. 1 (and receive circuits 145 and TX circuits 150 in FIG. 2) operate in a balanced manner Balun 130 provides an interface between RF circuitry 140 (or receive circuits 145 and TX circuits 150) and unbalanced (or single-ended) circuitry such as antenna 110 and antenna 115.

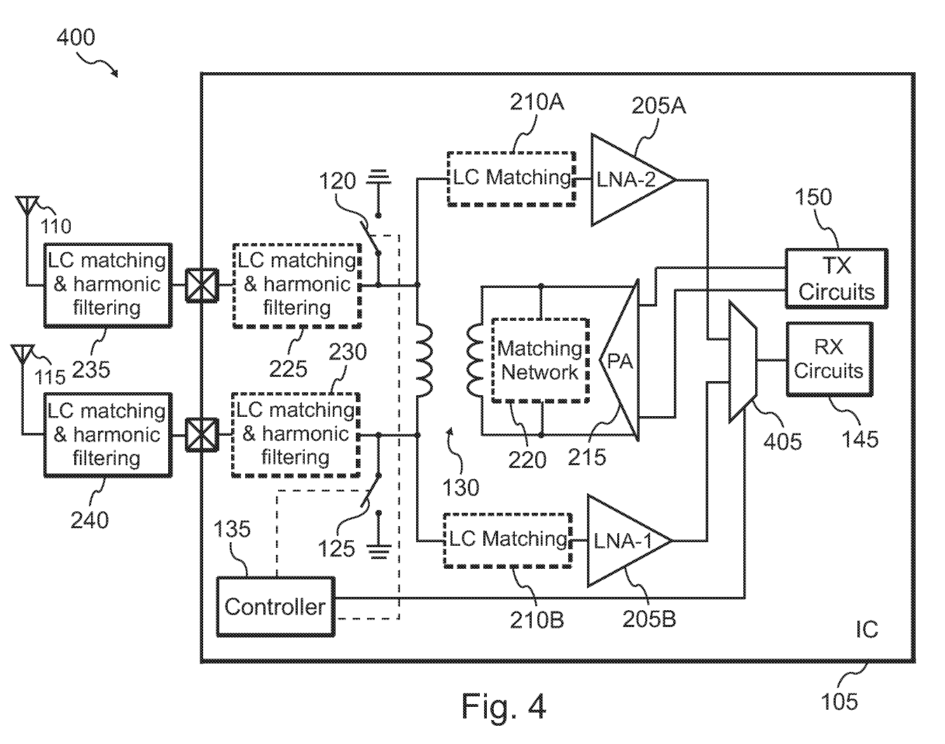

One aspect of the disclosure relates to providing integrated antenna control where one or more blocks of circuitry in RF circuits 140 does not operate in a balanced manner FIG. 4 illustrates a circuit arrangement 400 for antenna control according to an exemplary embodiment, where LNA circuits 205A and 205B do not operate in a balanced manner, i.e., do not use the balanced-unbalanced interface functionality of balun 130.

More specifically, the receive path of the apparatus shown in FIG. 4 does not use the balanced-unbalanced interface functionality of balun 130. To accommodate this scenario, two LNAs, 205A-205B, are used, rather than LNA 205 in FIG. 2. Referring again to FIG. 4, two LC matching networks 210A-210B are used (rather than matching network 210 in FIG. 2).

LNAs 205A and 205B may be powered selectively, depending on which of antennae 110-115 is used. More specifically, when antenna 110 is selected and used (by closing switch 125 and opening switch 120), LNA 205A may be powered to receive and amplify the RF signal that antenna 110 provides. LNA 205B may be powered down (e.g., by using biasing circuitry or a switch (not shown)) as desired to reduce the power consumption of IC 105.

Conversely, when antenna 115 is selected and used (by closing switch 120 and opening switch 125), LNA 205B may be powered to receive and amplify the RF signal from antenna 115. LNA 205A, however, may be powered down (e.g., by using biasing circuitry or a switch (not shown)) as desired to reduce the power consumption of IC 105.

Furthermore, circuit arrangement 400 uses a multiplexer (MUX) 405 to route the output signals of LNAs 205A-205B to receive circuits 145. More specifically, in response to a control signal from controller 135, MUX 405 routes selectively either the output signal of LNA 205A or the output signal of LNA 205B to receive circuits 145. Receive circuits 145 processes the received RF signal (from LNA 205A or LNA 205B), as discussed above.

Although circuit arrangement 400 illustrates the situation where the receive path of the apparatus in FIG. 4 does not use the balanced-unbalanced interface functionality of balun 130, other arrangements are possible, as persons of ordinary skill in the art will understand. For example, in some embodiments, the transmit path of IC 105 may not use the balanced-unbalanced interface functionality of balun 130. In this situation, two PAs (rather than PA 215) and, if desired, two matching networks (rather than matching network 220) may be used. Furthermore, a switching or routing mechanism, similar to MUX 405, may be used to route the transmit signal from transmit circuits 150 to the respective inputs of the two PAs.

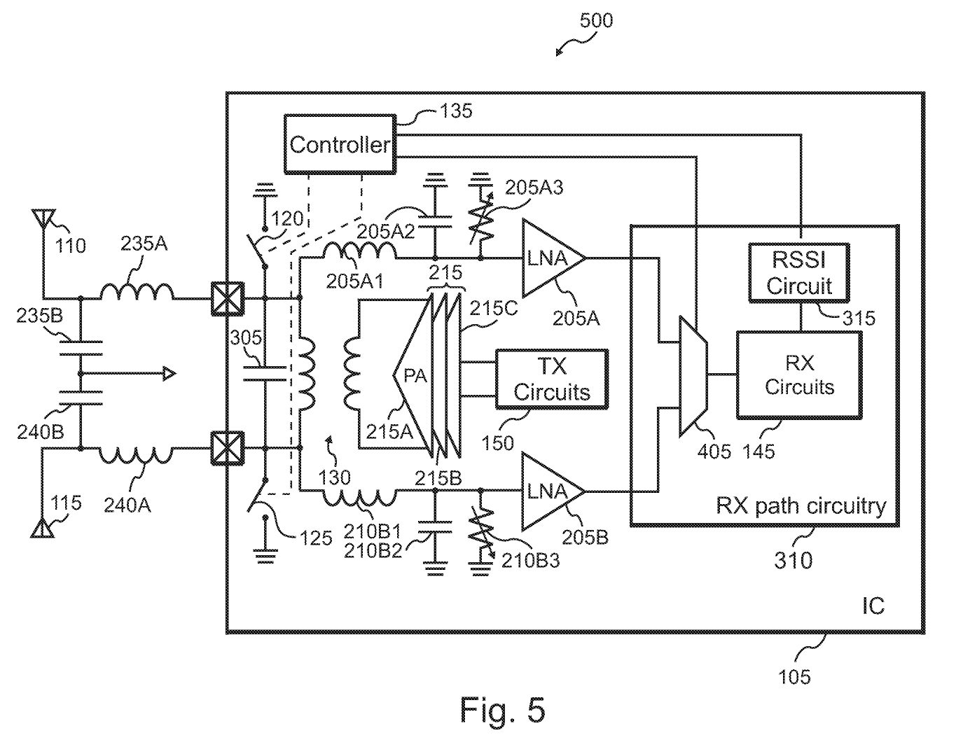

FIG. 5 illustrates a circuit arrangement 500 for antenna control according to an exemplary embodiment. Circuit arrangement 500 is similar to circuit arrangement 400 in FIG. 4, and operates in a similar manner Referring to FIG. 5, circuit arrangement 500 shows examples of some of the matching networks used to provide impedance matching between various circuit elements or blocks in the apparatus that includes IC 105.

More specifically, in the embodiment shown in FIG. 5, LC matching and harmonic filter 235 includes inductor 235A and capacitor 235B. Similarly, LC matching and harmonic filter 240 includes inductor 240A and capacitor 240B.

Capacitor 305 is used as another matching network. Capacitor 305 is coupled across the second port of balun 130. Together with LC matching and harmonic filter 235 and LC matching and harmonic filter 240, capacitor 305 provides impedance matching between antennae 110-115 and balun 130.

Furthermore, LC matching network 210A (see FIG. 4) is implemented in circuit arrangement 500 as inductor 205A1 and capacitor 205A2. Resistor 205A3 may be used to tune the matching network, provide variable attenuation, and/or provide bias to LNA 205A. Similarly, LC matching network 210B (see FIG. 4) is implemented in circuit arrangement 500 as inductor 205B1 and capacitor 205B2. Resistor 205B3 may be used to tune the matching network, provide variable attenuation, and/or provide bias to LNA 205B.

Note that, similar to the PA in FIG. 3, PA 215 in FIG. 5 includes several PA slices or PA circuits 215A-215C. PA slices 215A-215C may include circuitry for individual PAs. Depending on factors such as desired transmit power (or range), frequency or band of operation, and the like, one or more of PA slices 215A-215C may be activated and used to drive a selected one of antennae 110-115.

Circuit arrangement 500 shows three PA slices 215A, 215B, and 215C. As persons of ordinary skill in the art will understand, however, other numbers of PA slices may be used, depending on factors such as desired power levels, design and performance specifications, available technology, etc.

Circuit arrangement 500 shows receive path circuitry 310, which includes receive circuits 145 and RSSI circuit 315. RSSI circuit 315 determines a signal strength of the RF signal received by receive circuits 145 via a selected one of antennae 110-115. RSSI circuit 315 provides an indication of the received signal strength to controller 135. Controller 135 may use the information or indication of the received signal strength as a criterion in selecting one of antennae 110-115 by using switches 120-125, as described above in detail.

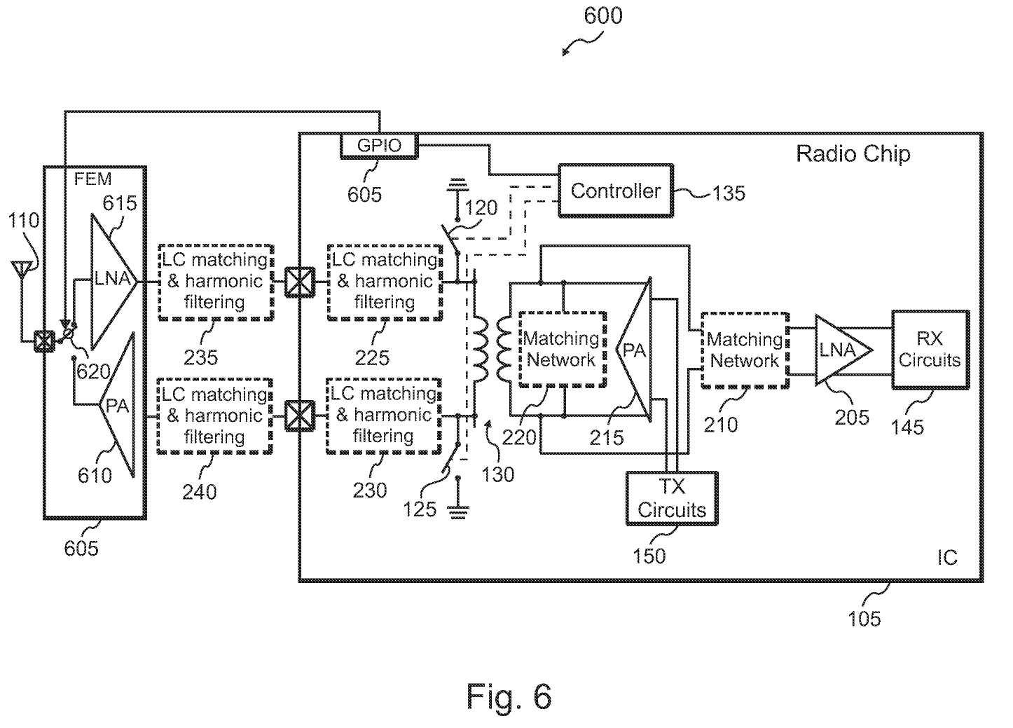

Another aspect of the disclosure relates to using integrated antenna control with RF apparatus that uses one antenna, rather than multiple antennae. FIG. 6 illustrates a circuit arrangement 600 according to an exemplary embodiment for antenna control in an apparatus with one antenna 110.

Circuit arrangement 600 includes antenna 110, which couples to IC 105 via FEM 605. In the embodiment shown, FEM 605 includes LNA 615 and PA 610. Using LNA 615 provides a gain block in closer proximity to antenna 110 (than, say, using an LNA in IC 105). As a result, the noise figure of circuit arrangement 600 during the receive mode of operation improves.

Furthermore, in the embodiment shown, FEM 605 includes PA 610. PA 610 may be used to provide higher transmit power in situations where the user of the apparatus desired more transmit power than PA 215 provides.

In some embodiments, LNA 615 and PA 610 are implemented in FEM 605 using III-VI semiconductor technologies. As persons of ordinary skill in the art will understand, however, other semiconductor technologies may be used, as desired. The choice of semiconductor technology depends on factors such as available technology, cost, desired performance specifications, and the like.

Referring to FIG. 6, FEM 605 is controlled by IC 105 to switch between transmit and receive. Depending on the mode of operation of the RF circuitry, the FEM couples the antenna to the receive circuits or to the transmit circuits.

More specifically, controller 135 sends a control signal to FEM 605 via GPIO port 625 (or other port or coupling mechanism between IC 105 and FEM 605, as desired). When RF signal transmission is desired, controller 135 causes switch 120 to close and switch 125 to open. As a result, RF signals from PA 215 are routed to FEM 605 via balun 130, matching network 230, and matching network 240.

The transmit signal from IC 105 (e.g., via matching network 240) to PA 610. Under control of controller 135, switch 620 in FEM 605 couples the output of PA 610 to antenna 110. Consequently, RF signals are transmitted via antenna 110.

Conversely, when RF signal reception is desired, under control of controller 135, switch 620 in FEM 605 couples antenna 110 to the input of LNA 615. Controller 135 further causes switch 120 to open and switch 125 to close. As a result, RF signals from LNA 615 are routed to LNA 205 and receive circuits 145 matching network 235, matching network 225, balun 130, and matching network 210. Consequently, RF signals are received via antenna 110 and processed by receive circuits 145.

Note that a variety of alternatives to circuit arrangement 600 are possible and contemplated. For example, in some embodiments, LNA 615 may be omitted, while PA 610 is used. As another example, in some embodiments, PA 610 may be omitted, while LNA 615 is used.

As yet another example, in some embodiments, both LNA 615 and PA 610 may be omitted. In this situation, FEM 605 includes switch 620, which serves as a receive/transmit switch for circuit arrangement 600. LNA 205 and PA 215 may be used in such an arrangement, as described above in detail.

Some of the exemplary embodiments described include matching networks and/or harmonic filters. A variety of types and configurations of matching networks and harmonic filters may be used, as persons of ordinary skill in the art will understand. For example, in some embodiments, capacitive (C) or inductive (L) matching networks and/or harmonic filters may be used. As another example, in some embodiments, -resistor-capacitor (RC) or resistor-inductor (RL) matching networks and/or harmonic filters may be used. As another example, in some embodiments, capacitor-inductor (LC) matching networks and/or harmonic filters may be used. As another example, in some embodiments, resistor-capacitor-inductor (RLC) matching networks and/or harmonic filters may be used.

Furthermore, in some embodiments, matching networks and/or harmonic filters may be coupled between two devices or blocks or components (e.g., in a cascade configuration). In some embodiments, rather than between two devices or blocks or components, matching networks and/or harmonic filters may be coupled to two nodes of the same device, block, or component. In some embodiments, matching networks and/or harmonic filters may be coupled in parallel with two or more devices or blocks or components. Other configurations are also possible and contemplated.

The choice of the matching network and harmonic filter type and topology, and the choice of circuit configuration and topology for the circuits and blocks in which matching networks and harmonic filters are included depends on a number of factors. Such factors include design and performance specifications (e.g., impedance levels of various devices, components, etc.; frequencies or frequency ranges of interest), available technology, IC die-area constraints, power consumption, and the like, as persons of ordinary skill in the art will understand.

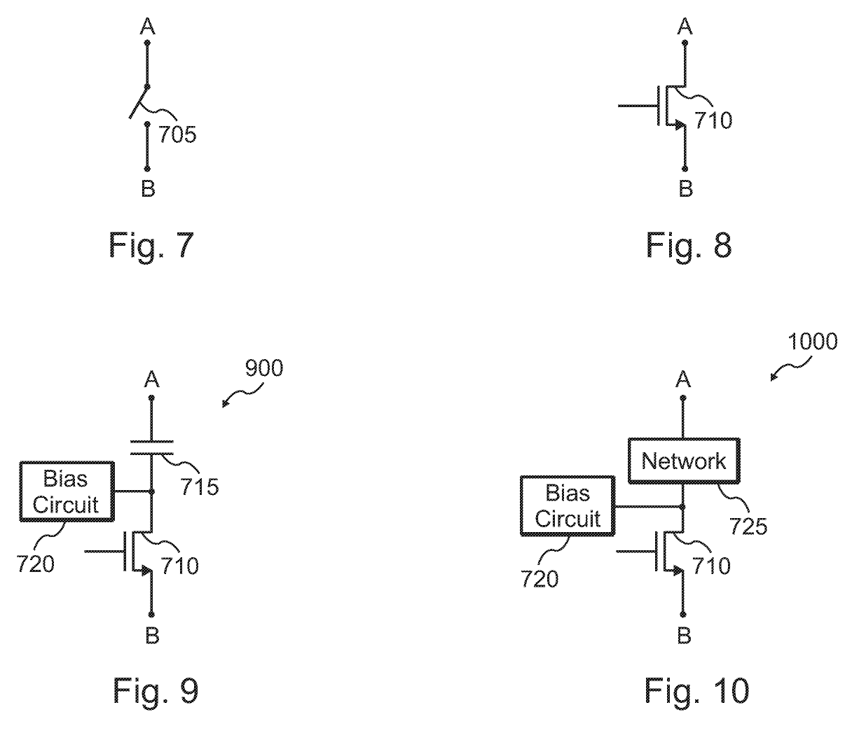

One aspect of the disclosure relates to circuitry or devices that may be used to implement switch 120 and/or switch 125. FIGS. 7-10 provide examples of such circuitry or devices according to exemplary embodiments.

FIG. 7 illustrates a switch 705 for use in apparatus according to exemplary embodiments. Switch 705 represents a generic switch (e.g., a switch approaching an ideal switch in its behavior and characteristics). When caused to close (e.g., by controller 135 (not shown)), switch 705 couples point A to point B with zero or negligible impedance, i.e., it approaches an ideal short-circuit between points A and B.

Switch 705 may be implemented using a variety of techniques and devices or circuits, as persons of ordinary skill in the art will understand. For example, in some embodiments, switch 705 may constitute a semiconductor device. As another example, in some embodiments, switch 705 may include more than one transistor, or transistors with different characteristics (e.g., p-type versus n-type, p-channel versus n-channel, etc.).

FIG. 8 shows a switch 710 for use in apparatus according to exemplary embodiments. Switch 710 constitutes an n-channel MOSFET. By applying an appropriate signal to the gate of switch 710, controller 135 (not shown) can cause switch 710 to turn on, and couple point A (drain) to point B (source).

Note that in other embodiments, switch 710 may constitute a p-channel MOSFET, as desired. In such embodiments, the control signal from controller 135 (not shown) is inverted (compared to when switch 710 constitutes an n-channel MOSFET) so as to properly control switch 710.

FIG. 9 depicts a circuit arrangement 900 to implement switch 120 and/or switch 125 in apparatus according to exemplary embodiments. In other words, circuit arrangement 900 may be substituted for switch 120 and/or switch 125 in the embodiments described.

Referring to FIG. 9, at RF frequencies, switch 120 or switch 125 generally function to provide an AC ground. Given that observation, capacitor 715 provides AC coupling between point A and transistor 710. Transistor 710 in turn provides coupling (in response a control signal from controller 135 (not shown) applied to its gate) between capacitor 715 and point B.

Bias circuit 720 provides appropriate DC bias for transistor 710. Bias circuit 720 may be implemented in variety of ways, as persons of ordinary skill in the art will understand. For example, in some embodiments, bias circuit 720 may simply include a resistor that couples the drain of transistor 710 to a voltage source (e.g., the supply voltage of IC 105).

FIG. 10 illustrates a circuit arrangement 1000 to implement switch 120 and/or switch 125 in apparatus according to exemplary embodiments. Put another way, circuit arrangement 1000 may be substituted for switch 120 and/or switch 125 in the embodiments described.

Circuit arrangement 1000 represents a more generalized version of circuit arrangement 900 (see FIG. 9). Referring to FIG. 10, circuit arrangement uses a general network 725 between point A and the drain of transistor 710. Network 725 generally provides an impedance that varies as a function of frequency. For example, network 725 may provide a reduced or minimum impedance at a single frequency, at multiple frequencies, in a range of frequencies, or in multiple ranges of frequencies in which the user of IC 105 seeks to receive or transmit RF signals.

In some embodiments, network 725 may include one or more inductors and one or more capacitors (i.e., an LC network). In some embodiments, network 725 may include one or more capacitors and one or more resistors (i.e., an RC network). In other embodiments, network 725 may include one or more inductors and one or more resistors (i.e., an RL network). In some embodiments, network 725 may include one or more resistors, one or more capacitors, and one or more inductors (i.e., an RLC network).

Given the AC coupling in FIG. 9 and possibly in FIG. 10 (depending on the topology of network 725), circuit arrangements 900 and 1000 may include protection circuitry to protect the relatively thin gate oxide of transistor 710 when in the off state. Such protection circuits may be implemented in a variety of ways and configurations, as persons of ordinary skill in the art will understand.

One aspect of the disclosure relates to sharing one or more antennas between RF circuits or devices, such as ICs that include RF circuitry (transmit circuits, receiver circuits, or both (transceiver circuits). Conventionally, in order for two ICs to share an antenna, external circuitry or modules such as diplexers are used.

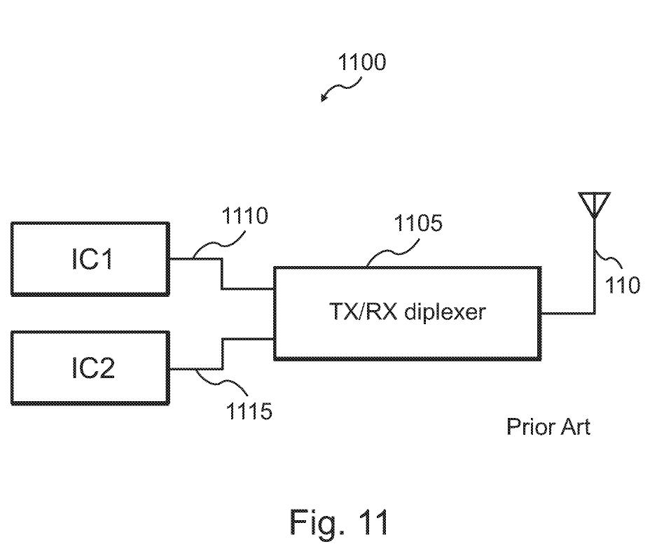

FIG. 11 shows a conventional circuit arrangement 1100 for sharing an antenna. IC1 couples to transmit/receive switch (labeled “TX/RX switch”) or diplexer 1105 via link 1110. Similarly, IC2 couples to transmit/receive diplexer or switch 1105 via link 1115. Under the control of IC1, switch 1105 allows either IC1 or IC2 to be coupled to antenna 110. In this manner, IC1 and IC2 can share antenna 110.

In exemplary embodiments according to the disclosure, internal switches (i.e., integrated within an IC) are used in ICs to allow sharing of one or more antennas, as described below in detail. Using the internal switches provides for reduced size, reduced part-count, reduced cost, and potentially increased performance.

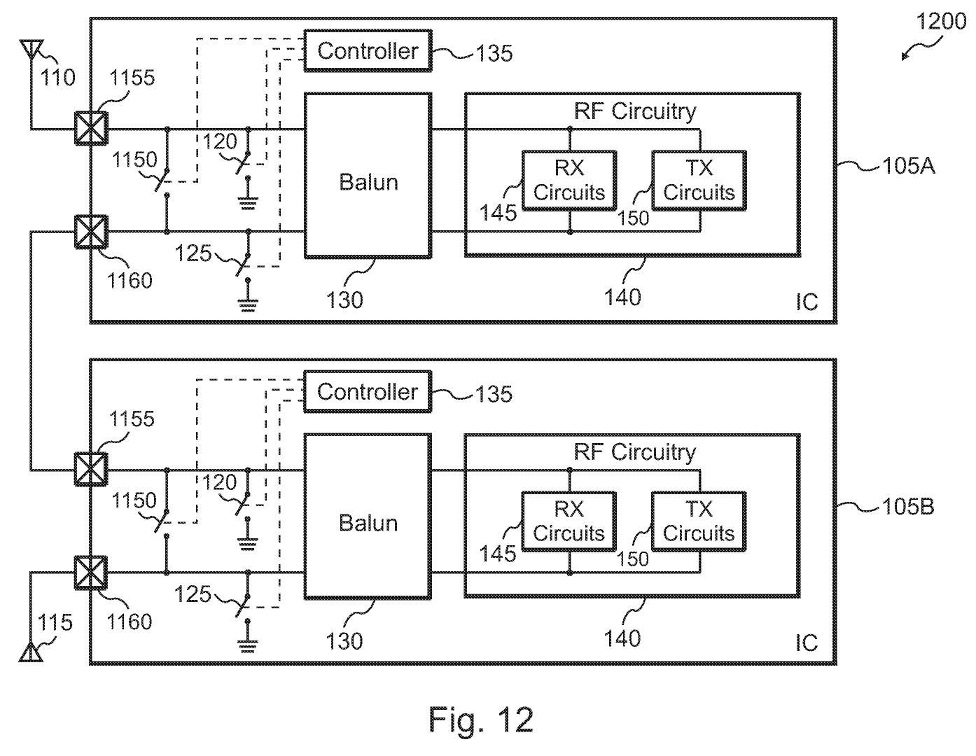

FIG. 12 depicts a circuit arrangement 1200 for sharing two antennas according to an exemplary embodiment. More specifically, FIG. 12 shows IC 105A coupled to IC 105B and to antennas 110 and 115. IC 105A and IC 105B are similar to IC 105 shown in FIG. 1, except that they include switch (or antenna sharing switch) 1150. Thus, IC 105A includes integrated switch 1150, coupled to terminals 1155 and 1160. Controller 135 in IC 105B controls the operation of switch 1150 in IC 105B (i.e., causes the switch to open and close). Terminals 1155 and 1160 constitute an antenna port of IC 105A.

Similarly, IC 105B includes integrated switch 1150, coupled to terminals 1155 and 1160. Terminals 1155 and 1160 constitute an antenna port of IC 105B. Controller 135 in IC 105B controls the operation of switch 1150 in IC 105B (i.e., causes the switch to open and close). Controller 135 in IC 105B controls the operation of (i.e., causes the switch to open and close).

Terminal 1155 of the antenna port of IC 105A is coupled to antenna 110. Similarly, terminal 1160 of the antenna port of IC 105B is coupled to antenna 115. Terminal 1160 of the antenna port of IC 105A is coupled to terminal 1155 of the antenna port of IC 105B.

As noted above, including switches 1150 in IC 105A and IC 105B, respectively, allows IC 105A and IC 105B to share one or more antennas. In the embodiment shown, two antennas, i.e., antenna 110 and antenna 115, are shared between IC 105A and IC 105B. More specifically, in order for IC 105A to use antenna 110 and antenna 115, controller 135 in IC 105A causes switch 1150 in IC 105A to open. Conversely, controller 135 in IC 105B causes switch 1150 in IC 105B to close and couple terminal 1155 of IC 105B to couple to terminal 1160 of IC 105B, in effect short-circuiting (or nearly or substantially short-circuiting in a practical, non-ideal implementation) the two terminals of the antenna port of IC 105B.

As a result, antenna 115 is coupled to terminal 1160 of the antenna port of IC 105A. In effect, antenna 110 is coupled to terminal 1155 of the antenna port of IC 105A, and antenna 115 is coupled to terminal 1160 of the antenna port of IC 105A. Thus, IC 105A (more specifically, RF circuitry 140) can use antenna 110 and antenna 115 to receive or transmit RF signals, as desired.

Conversely, in order for IC 105B to use antenna 110 and antenna 115, controller 135 in IC 105B causes switch 1150 in IC 105B to open. Furthermore, controller 135 in IC 105A causes switch 1150 in IC 105A to close and couple terminal 1155 of IC 105A to couple to terminal 1160 of IC 105A, in effect short-circuiting (or nearly or substantially short-circuiting in a practical, non-ideal implementation) the two terminals of the antenna port of IC 105A.

As a result, antenna 110 is coupled to terminal 1155 of the antenna port of IC 105B. In effect, antenna 110 is coupled to terminal 1155 of the antenna port of IC 105B, and antenna 115 is coupled to terminal 1160 of the antenna port of IC 105B. Thus, IC 105B (more specifically, RF circuitry 140) can use antenna 110 and antenna 115 to receive or transmit RF signals, as desired.

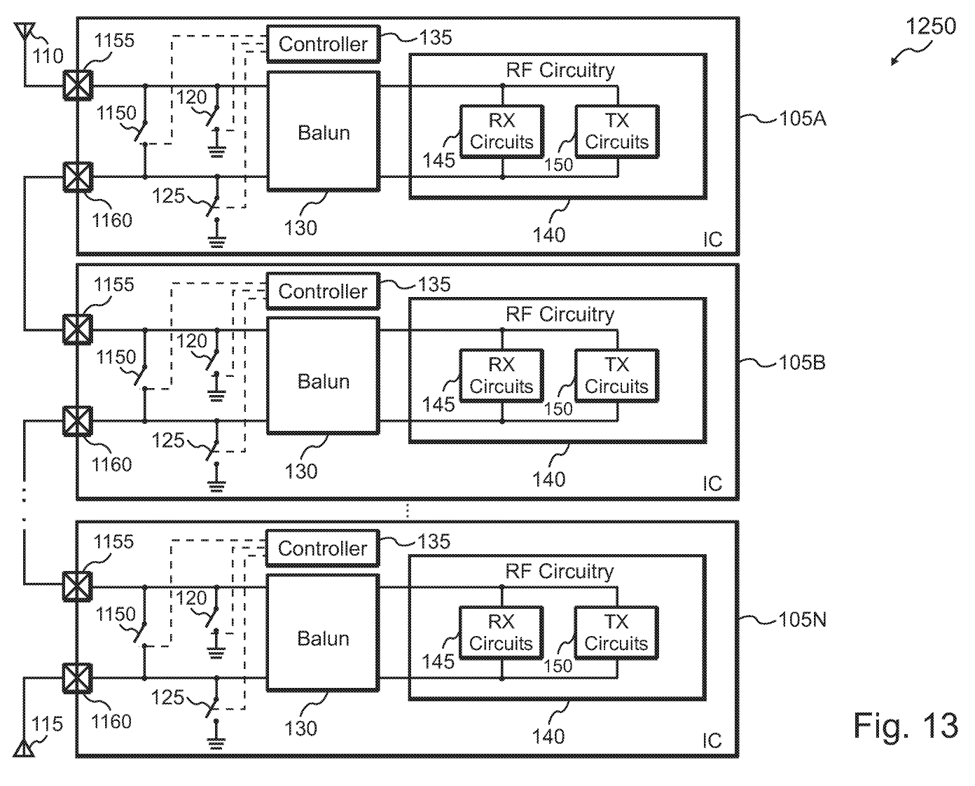

Thus, using the circuitry and techniques described above, IC 105A and IC 105B can share antenna 110 and antenna 115. This scheme of sharing antennas may be extended to more than two ICs and, generally, to N ICs, where N constitutes a positive integer greater than two. FIG. 13 illustrates a circuit arrangement 1250 for sharing two antennas among N ICs according to an exemplary embodiment.

Specifically, circuit arrangement 1250 includes N ICs, labeled IC 105A through IC 105N. Each of IC 105A through IC 105N includes an integrated switch 1150, coupled to terminal 1150 and terminal 1160 of the antenna port of that IC. IC 105A-105N are coupled in a daisy-chain fashion. In other words, terminal 1160 of IC 105A is coupled to terminal 1155 of IC 105B, whereas terminal 1160 of IC 105 is coupled to terminal 1155 of the following IC, and so on. Terminal 1155 of IC 105A is coupled to antenna 110. Terminal 1160 of IC 105N is coupled to antenna 115.

Sharing antennas 110 and 115 among ICs 105A-105N operates in a manner similar to that described above. For instance, in order for IC 105A to use antenna 110 and antenna 115, controller 135 in IC 105A causes switch 1150 of IC 105A to open. Controllers 135 in ICs 105B-105N, however, cause switches 1150 in ICs 105B-105N to close, effectively coupling antenna 115 to terminal 1160 of IC 105A. Thus, IC 105A has antenna 110 and antenna 115 coupled to its antenna port (i.e., terminal 1150 and terminal 1160, respectively). As a result, IC 105A (more specifically, RF circuitry 140) can use antenna 110 and antenna 115 to receive or transmit RF signals, as desired.

As another example, in order for IC 105N to use antenna 110 and antenna 115, controller 135 in IC 105N causes switch 1150 of IC 105N to open. Controllers 135 in the remaining ICs (ICs 105A-105N-1), however, cause switches 1150 in the remaining ICs to close, effectively coupling antenna 110 to terminal 1155 of IC 105N. Consequently, IC 105N has antenna 110 and antenna 115 coupled to its antenna port (i.e., terminal 1150 and terminal 1160, respectively). Thus, IC 105N (more specifically, RF circuitry 140) can use antenna 110 and antenna 115 to receive or transmit RF signals, as desired.

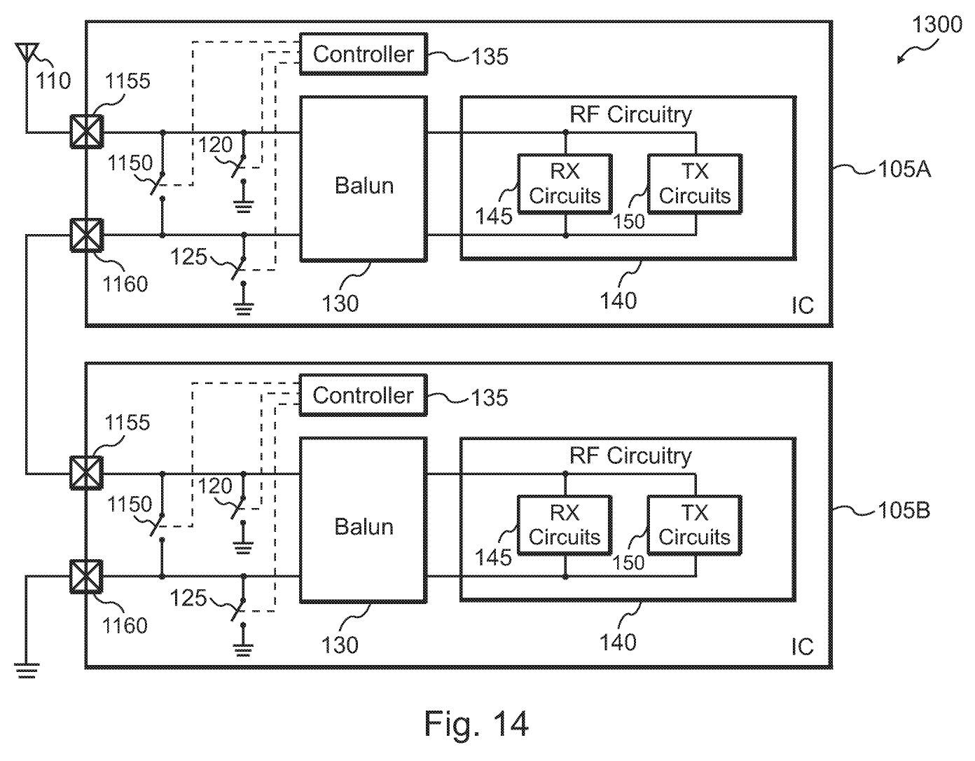

Another aspect of the disclosure relates to sharing a single antenna among multiple ICs. FIG. 14 shows a circuit arrangement 1300 for sharing an antenna according to an exemplary embodiment. Similar to FIG. 12, circuit arrangement 1300 in FIG. 14 includes IC 105A and IC 105B, each with an antenna port that includes terminals 1155 and 1160, and each with an integrated switch 1150 for sharing antenna 110.

Unlike FIG. 12, however, circuit arrangement 1300 in FIG. 14 includes a single antenna 110. Antenna 110 is coupled to terminal 1155 of IC 105A. Terminal 1160 of IC 105A is coupled to terminal 1155 of IC 105B. Terminal 1160 of IC 105 is coupled to ground.

Sharing antenna 110 works in a similar manner as described above in connection with FIG. 12. More specifically, referring to FIG. 14, in order for IC 105A to use antenna 110, controller 135 in IC 105A causes switch 1150 in IC 105A to open. Conversely, controller 135 in IC 105B causes switch 1150 in IC 105B to close and couple terminal 1155 of IC 105B to couple to terminal 1160 of IC 105B, in effect short-circuiting (or nearly or substantially short-circuiting in a practical, non-ideal implementation) the two terminals of the antenna port of IC 105B.

As a result, ground potential is coupled to terminal 1160 of the antenna port of IC 105A. In effect, antenna 110 is coupled to terminal 1155 of the antenna port of IC 105A, and ground potential is coupled to terminal 1160 of the antenna port of IC 105A. Thus, IC 105A (more specifically, RF circuitry 140) can use antenna 110 and antenna 115 to receive or transmit RF signals, as desired.

Conversely, in order for IC 105B to use antenna 110, controller 135 in IC 105B causes switch 1150 in IC 105B to open. Furthermore, controller 135 in IC 105A causes switch 1150 in IC 105A to close and couple terminal 1155 of IC 105A to couple to terminal 1160 of IC 105A, in effect short-circuiting (or nearly or substantially short-circuiting in a practical, non-ideal implementation) the two terminals of the antenna port of IC 105A.

As a result, antenna 110 is coupled to terminal 1155 of the antenna port of IC 105B. In effect, antenna 110 is coupled to terminal 1155 of the antenna port of IC 105B, and ground potential is coupled to terminal 1160 of the antenna port of IC 105B. Consequently, IC 105B (more specifically, RF circuitry 140) can use antenna 110 and antenna 115 to receive or transmit RF signals, as desired. Thus, using the circuitry and techniques described above, IC 105A and IC 105B can share antenna 110.

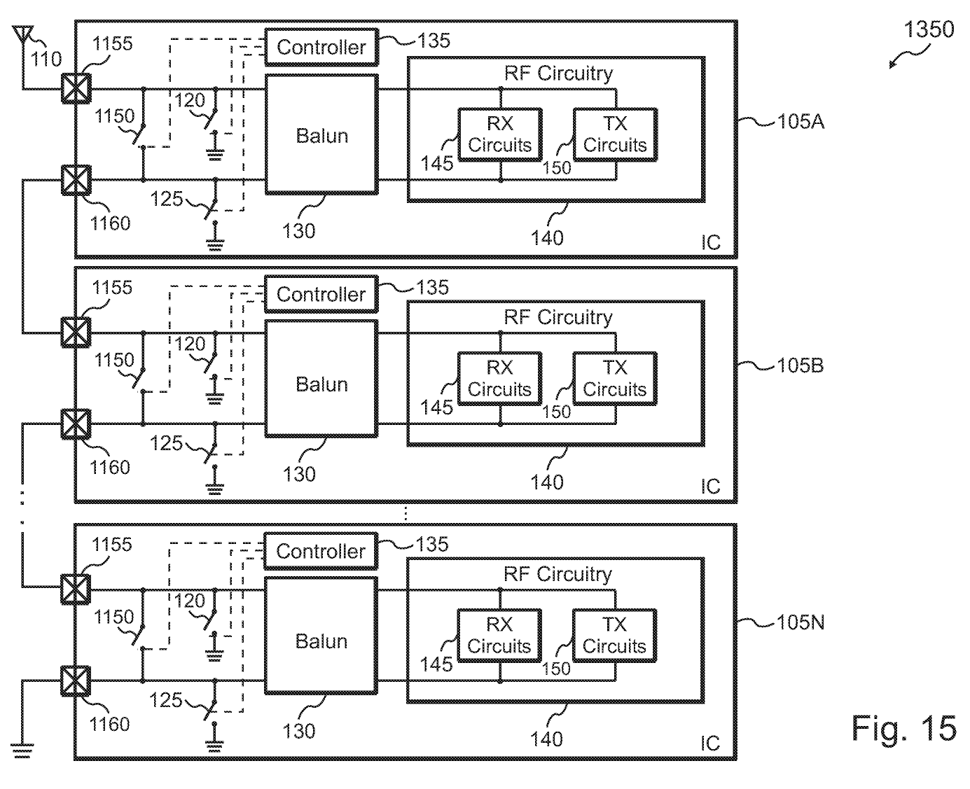

This scheme of sharing a single antenna may be extended to more than two ICs and, generally, to N ICs, where N constitutes a positive integer greater than two. FIG. 15 illustrates a circuit arrangement 1350 for sharing a single antenna among N ICs according to an exemplary embodiment.

Specifically, circuit arrangement 1350 includes N ICs, labeled IC 105A through IC 105N. Each of IC 105A through IC 105N includes an integrated switch 1150, coupled to terminal 1150 and terminal 1160 of the antenna port of that IC. IC 105A-105N are coupled in a daisy-chain fashion. In other words, terminal 1160 of IC 105A is coupled to terminal 1155 of IC 105B, whereas terminal 1160 of IC 105 is coupled to terminal 1155 of the following IC, and so on. Terminal 1155 of IC 105A is coupled to antenna 110. Terminal 1160 of IC 105N is coupled to ground potential.

Sharing antennas 110 among ICs 105A-105N operates in a manner similar to that described above. For instance, in order for IC 105A to use antenna 110, controller 135 in IC 105A causes switch 1150 of IC 105A to open. Controllers 135 in ICs 105B-105N, however, cause switches 1150 in ICs 105B-105N to close, effectively coupling the ground potential to terminal 1160 of IC 105A. Thus, IC 105A has antenna 110 and the ground potential coupled to its antenna port (i.e., terminal 1150 and terminal 1160, respectively). As a result, IC 105A (more specifically, RF circuitry 140) can use antenna 110 and antenna 115 to receive or transmit RF signals, as desired.

As another example, in order for IC 105N to use antenna 110, controller 135 in IC 105N causes switch 1150 of IC 105N to open. Controllers 135 in the remaining ICs (ICs 105A-105N-1), however, cause switches 1150 in the remaining ICs to close, effectively coupling antenna 110 to terminal 1155 of IC 105N. Consequently, IC 105N has antenna 110 and the ground potential coupled to its antenna port (i.e., terminal 1150 and terminal 1160, respectively). Thus, IC 105N (more specifically, RF circuitry 140) can use antenna 110 and antenna 115 to receive or transmit RF signals, as desired.

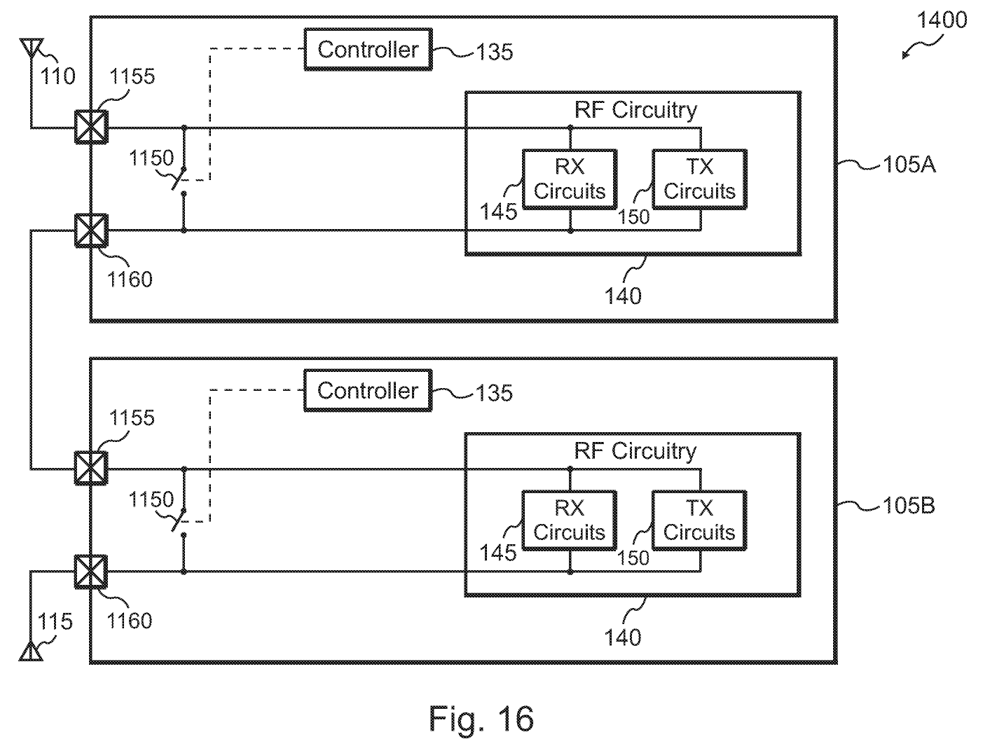

FIGS. 12-15 illustrate sharing one or more antennas among ICs such as shown in FIG. 1 (which may be extended to the ICs in FIGS. 2-6, by making appropriate modifications, such as including switch 1150 in the IC, as persons of ordinary skill in the art will understand). Such ICs include antenna control switches 120 and 125, as described above. The scheme for sharing one or more antennas among ICs, however, may be generally applied to any ICs that include RF circuitry. Thus, the scheme for sharing one or more antennas among ICs may be employed in ICs that include RF circuitry but lack antenna control switches 120 and 125. FIGS. 16-19 illustrate various exemplary embodiments of sharing one or more antennas among such ICs.

FIG. 16 illustrates a circuit arrangement 1400 for sharing two antennas according to another exemplary embodiment. Circuit arrangement 1400 is similar to, and operates in a similar manner as, the circuit arrangement in FIG. 12. Unlike the circuit arrangement in FIG. 12, however, IC 105A-105B in circuit arrangement 1400 constitute more general ICs. More specifically, IC 105A-105B in FIG. 16 include RF circuitry 140, coupled to terminal 1150 and terminal 1160. RF circuitry 140 may include receive circuits 145 and/or transmit circuits 150, as described above.

Similar to the circuit arrangement in FIG. 12, IC 105A and IC 105B in circuit arrangement 1400 include integrated switches 1150. Integrated switches 1150 provide a mechanism for sharing antenna 110 and antenna 115 between IC 105A and IC 105B.

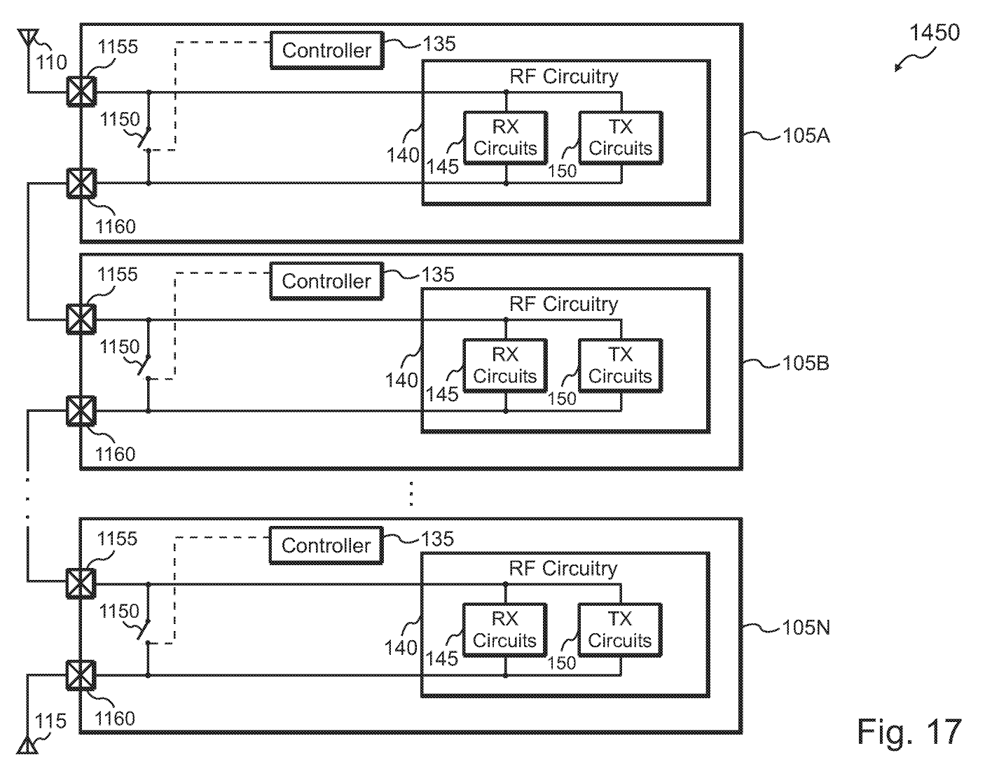

FIG. 17 shows a circuit arrangement 1450 for sharing two antennas among N ICs according to another exemplary embodiment. Circuit arrangement 1450 is similar to, and operates in a similar manner as, the circuit arrangement in FIG. 13. Unlike the circuit arrangement in FIG. 13, however, IC 105A-105N in circuit arrangement 1450 constitute more general ICs. More specifically, IC 105A-105N in FIG. 17 include RF circuitry 140, coupled to terminal 1150 and terminal 1160. RF circuitry 140 may include receive circuits 145 and/or transmit circuits 150, as described above.

Similar to the circuit arrangement in FIG. 13, IC 105A-105N in circuit arrangement 1450 include integrated switches 1150. Integrated switches 1150 provide a mechanism for sharing antenna 110 and antenna 115 among IC 105A-105N.

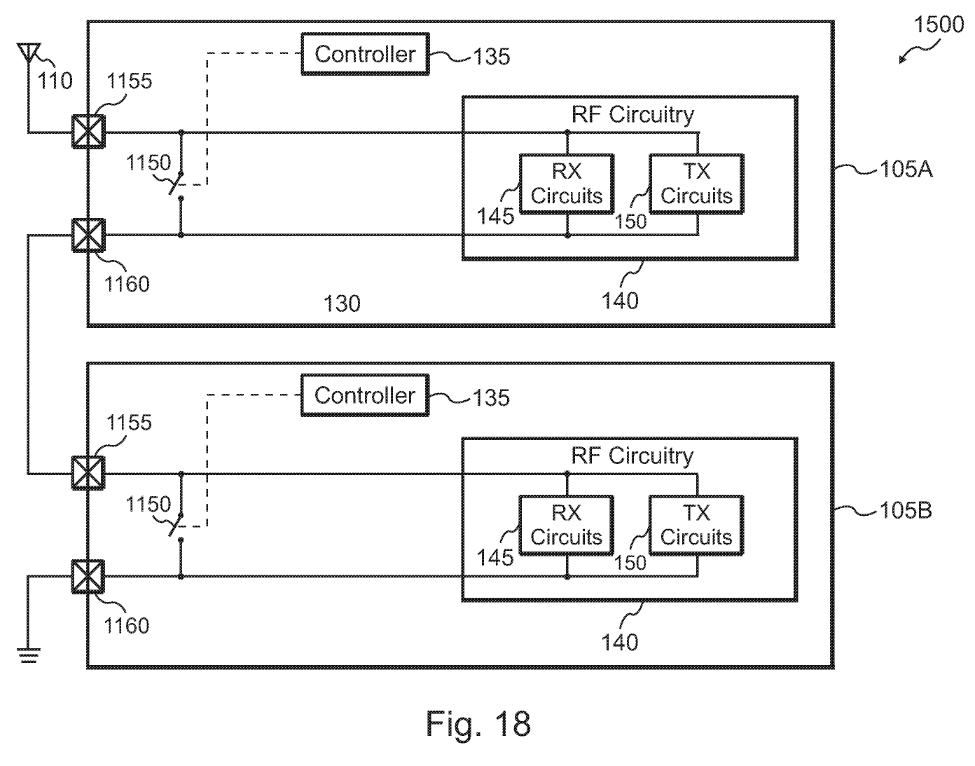

FIG. 18 illustrates a circuit arrangement 1500 for sharing a single antenna according to another exemplary embodiment. Circuit arrangement 1500 is similar to, and operates in a similar manner as, the circuit arrangement in FIG. 14. Unlike the circuit arrangement in FIG. 14, however, IC 105A-105B in circuit arrangement 1500 constitute more general ICs. More specifically, IC 105A-105B in FIG. 16 include RF circuitry 140, coupled to terminal 1150 and terminal 1160. RF circuitry 140 may include receive circuits 145 and/or transmit circuits 150, as described above.

Similar to the circuit arrangement in FIG. 14, IC 105A and IC 105B in circuit arrangement 1500 include integrated switches 1150. Integrated switches 1150 provide a mechanism for sharing antenna 110 between IC 105A and IC 105B.

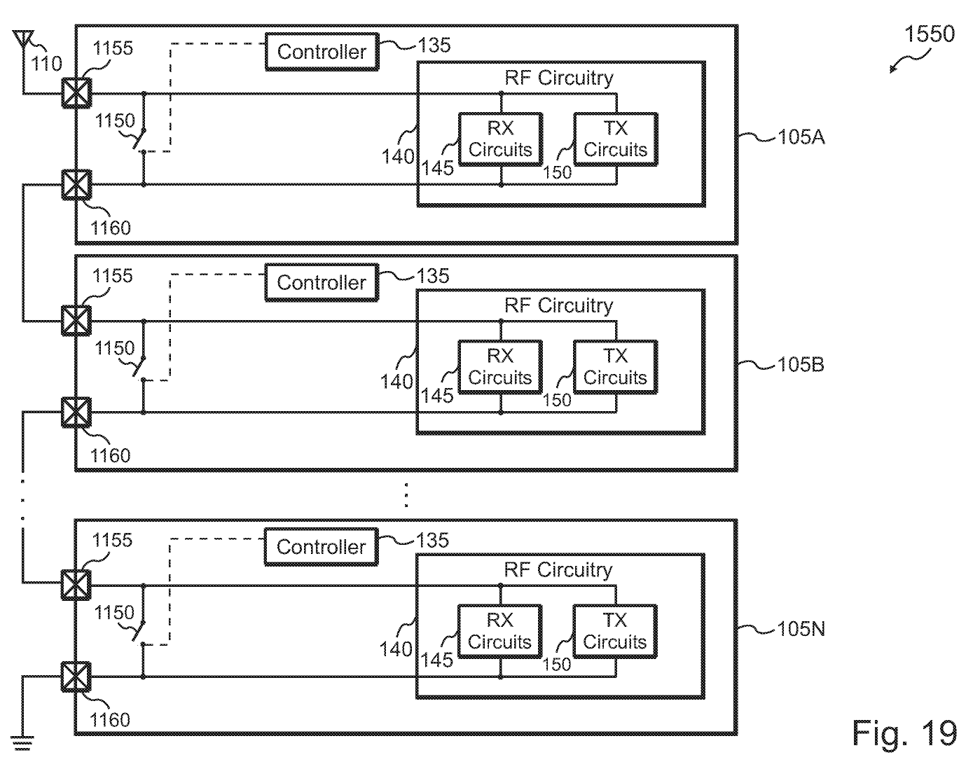

FIG. 19 shows a circuit arrangement 1550 for sharing a single antenna among N ICs according to another exemplary embodiment. Circuit arrangement 1550 is similar to, and operates in a similar manner as, the circuit arrangement in FIG. 15. Unlike the circuit arrangement in FIG. 15, however, IC 105A-105N in circuit arrangement 1550 constitute more general ICs. More specifically, IC 105A-105N in FIG. 19 include RF circuitry 140, coupled to terminal 1150 and terminal 1160. RF circuitry 140 may include receive circuits 145 and/or transmit circuits 150, as described above.

Similar to the circuit arrangement in FIG. 13, IC 105A-105N in circuit arrangement 1550 include integrated switches 1150. Integrated switches 1150 provide a mechanism for sharing antenna 110 among IC 105A-105N.

Another aspect of the disclosure relates to a coordination or communication mechanism among ICs that share one or more antennas. More specifically, as noted above, controller 135 in IC 105 in FIGS. 12-19 controls integrated switch 1150, which is used to share one or more antennas. For example, in order for two ICs to share one or more antennas, switch 1150 in one IC is closed, whereas switch 1150 in the other IC is opened.

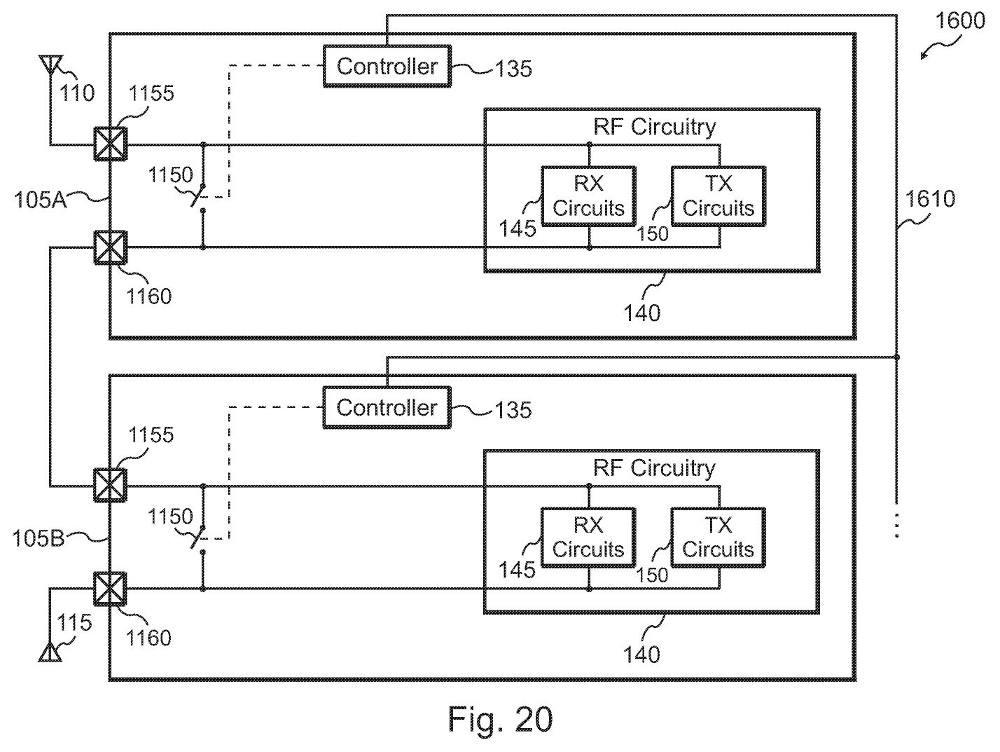

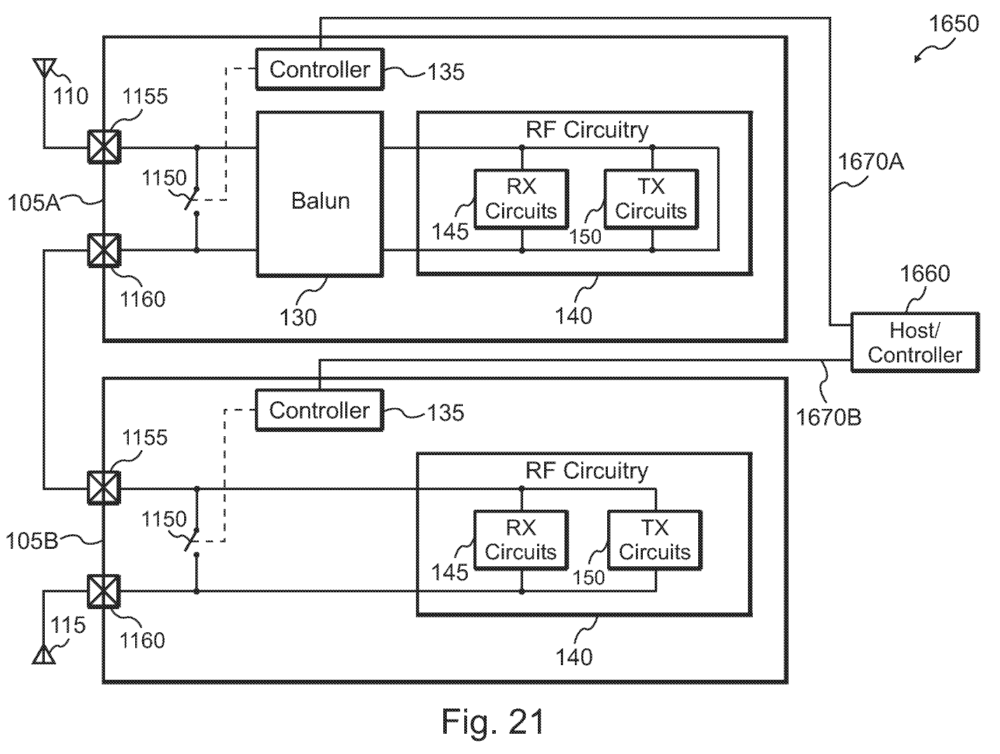

To coordinate the opening and closing of switches 1150 by controllers 135 among the ICs that share one or more antennas, several mechanisms may be used. FIGS. 20-21 provide exemplary embodiments of such mechanisms.

FIG. 20 shows a circuit arrangement 1600 for coordination of antenna sharing according to an exemplary embodiment. More specifically, circuit arrangement 1600 includes a link 1160 to which controller 135 of IC 105A and controller 135 of IC 105B are coupled. Through link 1610, controller 135 of IC 105A and controller 135 of IC 105B coordinate the opening and closing of switch 1150 in IC 105A and switch 1150 in IC 105B. The opening and closing of switch 1150 in IC 105A and switch 1150 in IC 105B allows the sharing of antenna 110 and antenna 115, as described above.

Controller 135 of IC 105A and controller 135 of IC 105B use a signaling or control or coordination mechanism through link 1610 to facilitate the opening and closing of switch 1150 in IC 105A and switch 1150 in IC 105B so that antenna 110 and antenna 115 are shared between IC 105A and IC 105B.

In some embodiments, link 1610 constitutes a serial communication mechanism, and controller 135 of IC 105A and controller 135 of IC 105B use a serial communication protocol or standard to communicate information and coordinate proper opening and closing of switch 1150 in IC 105A and switch 1150 in IC 105B to facilitate antenna sharing. Without limitation, examples of such serial protocols include I²C, SMBus, SPI, RS-232, etc.

In some embodiments, link 1610 constitutes a parallel communication mechanism, and controller 135 of IC 105A and controller 135 of IC 105B use a parallel communication protocol or standard to communicate information and coordinate proper opening and closing of switch 1150 in IC 105A and switch 1150 in IC 105B to facilitate antenna sharing. In some embodiments, link 1610 constitutes a custom or special-purpose link or handshaking mechanism through which controllers 135 of IC 105A and IC 105B can exchange status and control signals or information in order to and coordinate proper opening and closing of switch 1150 in IC 105A and switch 1150 in IC 105B to facilitate antenna sharing.

FIG. 21 depicts a circuit arrangement 1650 for coordination of antenna sharing according to another exemplary embodiment. Circuit arrangement 1650 includes a host (or controller) 1660. Host 1660 is coupled to controller 135 of IC 105A via link 1670A. Similarly, host 1660 is coupled to controller 135 of IC 105B via link 1670B. Through links 1670A-1670B, host 1660 provides instructions or commands to controller 135 in IC 105A and controller 135 in IC 105B, respectively.

In response to the instructions or commands, controller 135 in IC 105A and controller 135 in IC 105B coordinate proper opening and closing of switch 1150 in IC 105A and switch 1150 in IC 105B to facilitate antenna sharing. Furthermore, in some embodiments, through links 1670A-1670B, host 1660 can exchange status information and/or other signaling information (e.g., a request for an IC to use antenna 110 and antenna 115) with controller 135 in IC 105A and controller 135 in IC 105B, respectively, as desired.

Note that, although FIGS. 20-21 show two ICs, the mechanism and techniques shown may be extended to a larger number of ICs, such as N ICs (see, for example, FIGS. 15, 17, and 19) by making appropriate modifications, as persons of ordinary skill in the art will understand. Furthermore, note that, although FIGS. 20-21 show two antennas shared between the ICs, the mechanism and techniques shown may be applied to sharing a single antenna (see, for example, FIGS. 15, 17, and 19) by replacing antenna 115 with circuit ground (e.g., coupling terminal 1160 of IC 105B to ground potential).

Referring to FIGS. 12-21, terminal 1155 and terminal 1160 may constitute a variety of features or coupling mechanisms in IC 105A, B, etc. For example, in some embodiments, terminal 1155 and terminal 1160 may constitute pins of the respective IC packages. As another example, in some embodiments, terminal 1155 and terminal 1160 may constitute pads of the respective IC packages. As yet another example, in some embodiments, terminal 1155 and terminal 1160 may constitute bond wires of the respective IC packages. In some embodiments, the various features (e.g., pins, bond wires, pads, etc.) may be combined in order to implement terminal 1155 and terminal 1160, as desired.

Furthermore, referring to FIGS. 12-21, integrated switches 1150 may be implemented in a variety of ways, as persons of ordinary skill in the art will understand. Without limitation, switches 1150 may be implemented as shown in any of FIGS. 7-10 and described above.

One aspect of the disclosure relates to ICs that can accommodate one or more RF technologies, standards, or protocols, and include antenna control and/or antenna sharing switches. For example, in exemplary embodiments, IC 105 or an apparatus that includes IC 105 (or multiple ICs that share one or more antennas, as described above), may accommodate and operate in accordance with standards such as Wi-Fi, Bluetooth, ZigBee, cellular (2G, 2.5G, 3G, 4G, LTE, etc., including implementations such as GSM, etc.), and the like, as desired. Depending on whether RF signal reception, RF signal transmission, or both, are desired, receive circuits 145, transmit circuits 150, or both, respectively, may be used to accommodate desired RF technologies, standards, or protocols.

Referring to the figures, persons of ordinary skill in the art will note that the various blocks shown might depict mainly the conceptual functions and signal flow. The actual circuit implementation might or might not contain separately identifiable hardware for the various functional blocks and might or might not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation. Other modifications and alternative embodiments in addition to those described here will be apparent to persons of ordinary skill in the art. Accordingly, this description teaches those skilled in the art the manner of carrying out the disclosed concepts, and is to be construed as illustrative only. Where applicable, the figures might or might not be drawn to scale, as persons of ordinary skill in the art will understand.

The forms and embodiments shown and described should be taken as illustrative embodiments. Persons skilled in the art may make various changes in the shape, size and arrangement of parts without departing from the scope of the disclosed concepts in this document. For example, persons skilled in the art may substitute equivalent elements for the elements illustrated and described here. Moreover, persons skilled in the art may use certain features of the disclosed concepts independently of the use of other features, without departing from the scope of the disclosed concepts.

1-14. (canceled)

15. A method of sharing at least one antenna between a first integrated circuit (IC) having a first switch integrated in the first IC and coupled to a first antenna port, and a second IC having a second switch integrated in the second IC and coupled to a second antenna port, the method comprising:
closing the first switch to couple the at least one antenna to the second IC; and
opening the second switch to in order for RF circuitry in the second IC to use the at least first antenna.

16. The method according to claim 15, further comprising:
closing the second switch to couple the at least one antenna to the first IC; and
opening the first switch to in order for RF circuitry in the first IC to use the at least first antenna.

17. The method according to claim 15, wherein the first switch is coupled across the first antenna port.

18. The method according to claim 16, wherein the second switch is coupled across the second antenna port.

19. The method according to claim 16, further comprising using a first controller to control the first switch and using a second controller to control the second switch, wherein the first and second controllers are coupled via a link to facilitate opening and closing of the first and second switches to coordinate sharing the at least one antenna.

20. The method according to claim 16, further comprising:
using a first controller to control the first switch;
using a second controller to control the second switch; and
using a host coupled to the first and second controllers to facilitate opening and closing of the first and second switches to coordinate sharing the at least one antenna.
